(19) United States
(12) Patent Application Publication
(10) Pub. No.: US 2023/0421020 A1
(43) Pub. Date: Dec. 28, 2023

(54) VIBRATION DAMPER FOR A GEARED MOTOR UNIT FOR AN ELECTRICAL ACTUATOR OF A DISC BRAKE

(71) Applicant: HITACHI ASTEMO FRANCE, Drancy (FR)

(72) Inventors: Nicolas BRIANE, Trelaze (FR); Benoît DE CHAMPEAUX, Aubervilliers (FR)

(21) Appl. No.: 18/253,245

(22) PCT Filed: Nov. 4, 2021
(86) PCT No.: PCT/EP2021/080586

§ 371 Date: May 17, 2023

(30) Foreign Application Priority Data
Nov. 19, 2020 (FR) 2011899

(51) Int. Cl. H02K 5/24; F16H 57/028; B60T 13/74; F16D 65/18; F16H 57/031; H02K 7/116

(52) U.S. Cl. CPC H02K 5/24; F16H 57/028; B60T 13/746; F16D 65/18; F16H 57/031; H02K 7/116; F16H 2057/02034

(57) ABSTRACT

A noise-damping device for a geared motor unit including a housing containing an electric motor having an axis, and a reduction mechanism is disclosed. The device includes two coaxial rings, connected radially to one another by a connection ring, including a first ring positioned inside a second ring, the damping device being able to be positioned at an end part of the electric motor, the first and second rings being arranged against the end part of the electric motor so as to damp the movements of the electric motor in the housing in radial and axial directions.

The invention relates to an electric motor gear unit mounted at the end of a disc brake actuator, which comprises a motor mounted cantilevered, parallel to the output of the reduction gear and on the same side.

### STATE OF THE ART

In the field of brakes, for the car industry in general, and more particularly disc brakes, it has become common to install an electric actuator directly on the brake. This actuator is generally used for the parking and emergency brake function, but sometimes also as a service brake.

This actuator generally consists of an electric motor gear unit (MGU), which comprises a drive device (or motor) and a transmission device (or reduction mechanism), the two devices being interconnected (the motor actuating the transmission device) and being enclosed in a protective casing comprising on the one hand a housing having two openings and on the other hand two closure covers attached and fixed on each of the openings.

A first opening gives access to a first part of the housing, wider than a second part of the housing, the first part of the housing accommodating the transmission device comprising several gear stages linked to each other, and in particular a planetary gear (which may comprise two stages) and comprising at least one ring gear with internal toothing.

The second part of the housing, narrower than the first and integral with the first, accommodates the drive device (or motor). This second part of the housing will be called the “drive device accommodation unit” and has the second opening which gives access to the motor.

In general, the housing has a shape which substantially matches the external shape of the two devices connected together.

The two covers are fixed to the housing by welding.

It often happens that electric motor gears have drawbacks in terms of vibration: in fact, the vibrations can be a source of discomfort for the occupants of the vehicle, in particular through the noises they cause, and/or they can damage the motor gear.

The invention aims in particular to attenuate the noises and the vibrations which are generated in the drive device accommodation unit, in particular those generated by the motor in the housing.

### DISCLOSURE OF THE INVENTION

To this end, the subject of the invention is a motor gear unit for a disc brake electric actuator, said motor gear unit comprising a housing containing an electric motor having an axis defining an axial direction, and a reduction mechanism mechanically connected to said electric motor to provide at the output of said reduction mechanism a rotational drive of a shaft along an output axis parallel to said axial direction. The motor gear unit is remarkable in that it comprises a damping device capable of being positioned on an end part of the electric motor comprising an element for axial damping of movements of the motor in said axial direction and an element for radial damping of movements of the motor in a radial direction of the electric motor.

Thus produced, the motor gear unit according to the invention blocks the movements of the electric motor in the housing both in an axial direction and in a radial direction, which leads to limiting the vibrations of the motor and therefore the production of noise.

According to other advantageous characteristics specific to the invention, the motor gear unit according to the invention also comprises the following characteristics, taken separately or in combination:

In an embodiment presented below, the damping device comprises two coaxial rings among which:
a first ring bearing against a cylindrical wall presented by said end part of the electric motor, said first ring forming said radial damping element, and
a second ring bearing against an external surface of the motor, perpendicular to said axial direction, said second ring forming said axial damping element.

It is advantageously provided that the cylindrical wall and the annular surface are axially offset with respect to each other. Thus, the damping can also take place in directions that are intermediate between the axial and radial directions.

In addition, the first ring and the second ring are advantageously radially connected to each other by a connecting ring, the first ring being positioned inside the second ring and bearing against a first shoulder which the end of the motor presents. This embodiment makes it possible to produce the damping device in a single piece, which facilitates the assembly of the motor gear unit.

Still further, according to another advantageous embodiment, the connecting ring comprises a radial positioning bead, capable of fitting into a groove arranged in said end part of the electric motor. Assembly is also facilitated by this embodiment, because the bead and the groove make it possible to hold the damping device in place during assembly.

Advantageously, the first ring has at least one element in relief on its outer peripheral wall. In addition, the first ring preferably has several elements in relief uniformly distributed on said outer peripheral wall.

According to an embodiment, the damping device is produced in a single piece by moulding.

In addition, the motor gear unit according to the invention comprises a damping device produced from ethylene-propylene-diene monomer, having a Shore D hardness comprised between 30 and 50, preferably of substantially 40.

The invention also relates to a damping device for a motor gear unit, for a disc brake electric actuator, as defined above. The damping device is remarkable in that it comprises an element for axial damping of movements of the motor in said axial direction and a radial damping element of the movements of the motor in a radial direction of the electric motor.

The damping device according to the invention preferably comprises the following characteristics, taken separately or in combination:
according to an advantageous embodiment, it comprises two coaxial rings, among which a first ring, capable of bearing against a cylindrical wall which said end part of the electric motor presents, said first ring forming said radial damping element, and a second ring, capable of bearing against an external surface of the motor, perpendicular to said axial direction, said second ring forming said axial damping element,
the first ring and the second ring are preferably radially connected to each other by a connecting ring, the first ring being positioned inside the second ring,
the connecting ring further comprises a radial positioning bead, capable of fitting into a groove arranged in said end part of the electric motor,
the first ring preferably has at least one element in relief on its outer peripheral wall and, preferably, said first ring advantageously having several elements in relief uniformly distributed on said outer peripheral wall,
the device is produced in a single piece by moulding according to an advantageous embodiment,
the device is preferably produced from ethylene-propylene-diene monomer and has a Shore D hardness between 30 and 50, preferably of substantially 40.

The invention also relates to a cover for a motor gear unit as defined above, the housing of the motor gear unit having an opening for access to the electric motor, the cover being capable of closing the access opening and being equipped with a damping device also as defined above.

According to an advantageous embodiment, the damping device is secured to the bottom of the cover by overmoulding. This embodiment makes it possible to equip the covers that already exist.

According to an alternative embodiment, the damping device is produced in a single piece with the cover. By “a single piece” is meant the fact that the cover and the damping device are produced from the same material and together during the production of the cover, for example by moulding.

Finally, the invention relates to an assembly comprising a disc brake, in particular with a movable, in particular sliding, calliper, and an actuator associated with a motor gear unit as defined above.

### PRESENTATION OF THE FIGURES

Other advantages and characteristics of the invention will become apparent on examination of the detailed description of an embodiment that is in no way limitative, and from the attached drawings, in which:

FIG. 1 is a perspective view of a damping device according to the invention,

FIG. 2 is a perspective view of a motor gear unit according to the invention, which comprises a damping device according to the invention and

FIG. 3 is a partial cross-section view of a part III of the motor gear unit shown in FIG. 2, for a disc brake electric actuator, according to the invention.

### DESCRIPTION OF THE FIGURES

The terms “upper”, “lower”, “left”, “right”, “top”, “bottom” etc. are used in the following description merely to allow the reader to find their bearings in the figures: it should be understood that these terms are not limitations of the invention.

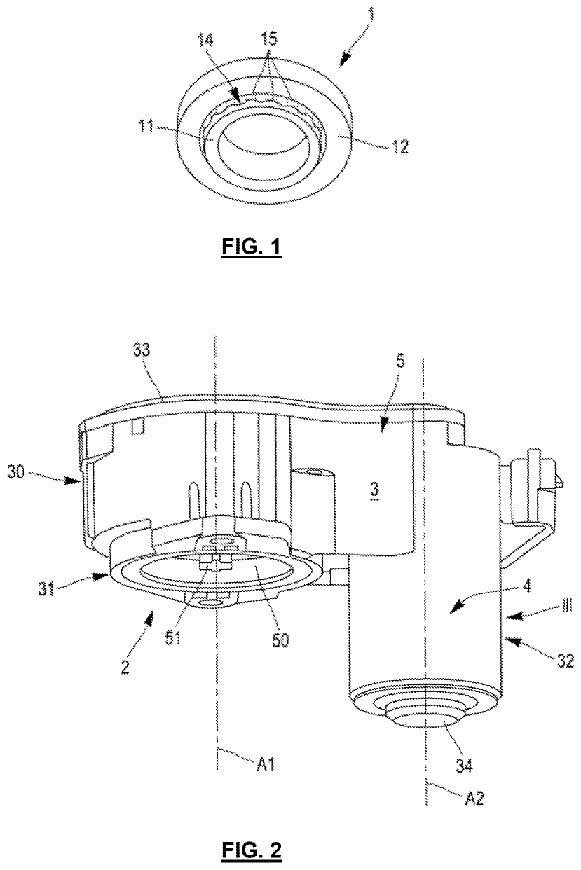

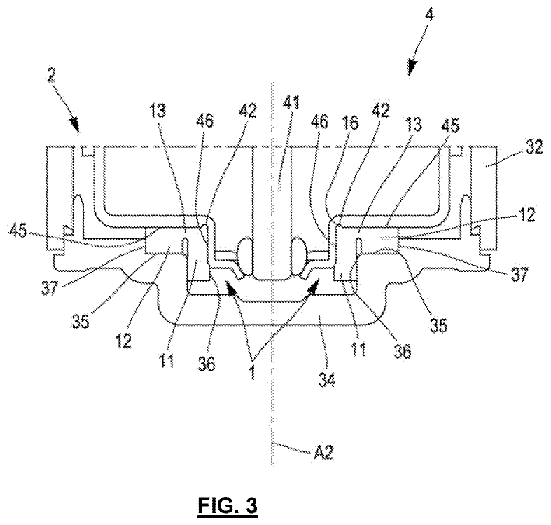

The damping device 1 which is the subject of the invention is shown alone in FIG. 1. In FIGS. 2 and 3, it is mounted in a motor gear unit 2.

The damping device 1 shown in the figures is designed to damp the movements of a motor contained in the motor gear unit 2, these movements being the source of noises: it is therefore appropriate to present, first of all, the elements which are comprised in the motor gear unit 2 and their arrangement, so as to identify the zone of the motor gear unit at the origin of the noise and in which the damping device 1 according to the invention is implemented.

FIG. 2 shows the motor gear unit 2 as a whole, the damping device 1 being invisible in this figure because it is enclosed in the motor gear unit 2.

The motor gear unit 2 is designed for a disc brake actuator, of the type comprising a movable calliper mounted sliding on a yoke, the actuator driving the calliper in displacement under the action of the motor gear unit or of a hydraulic piston.

In FIG. 2, showing an example of such a motor gear unit, it can be seen that it comprises a housing 3, forming a protective casing for the motor gear unit 2, the housing 3 having two parts:
an upper part 30, having substantially a bean-shaped cross section, accommodating two cylindrical shapes: a first cylindrical shape 31 located on the left in the upper part 30 in FIG. 2 and a second cylindrical shape 32 located on the right in the upper part 30 in FIG. 2,
a lower part, formed by the second cylindrical shape 32 which projects downwards and which extends over a height substantially identical to the height of the upper part 30.

A part of the electric motor 4 of this motor gear unit 2 is contained in the lower part (or second cylindrical shape) 32, is partially visible in FIG. 3, the electric motor extending into the upper part.

The motor gear unit 2 also comprises a reduction mechanism 5 the output 50 of which is visible and corresponds to the first cylindrical shape 31 in the lower part of the upper part 30 of the housing.

The reduction mechanism 5 is mechanically connected to the electric motor 4, by means of toothed wheel gear systems, and in particular a planetary system which gives the bean shape of the upper part 30 of the housing 3.

It is noted in FIG. 2 that the output 50 of the reduction mechanism has a shaft 51 which extends along an output axis A1.

The shaft 51 makes it possible to control the actuator at the origin of the movement of the disc brake calliper piston (actuator and disc brake not shown), typically of the screw-nut type.

The upper part 30 of the housing is closed by a cover 33.

The lower part 32 of the housing, which accommodates the electric motor 4, is also closed by a cover 34.

The motor 4 has an axis A2, defining an axial direction of the motor parallel to the output axis A1 of the shaft 51 which is connected to the reduction mechanism of the motor gear unit 2.

The motor 4 also comprises a shaft 41, with axis A2.

The invention is implemented in this lower part 32 of the housing 3 and it is shown in detail in FIG. 3: the damping device 1 is positioned between the motor 4 and the cover 34.

The damping device 1 is also shown alone in FIG. 1: it comprises two coaxial rings among which a first ring 11, called “inner”, positioned in a second ring 12 called “outer”.

The two coaxial rings 11 and 12 both project from a coaxial connecting ring 13, which forms an edge common to the two rings 11 and 12 and which is more particularly visible in FIG. 3.

This damping device 1 is produced in a single piece by moulding from ethylene-propylene-diene monomer (or EPDM) and has a Shore D hardness of substantially 40.

It should be noted that the first, inner, ring 11 is higher than the second, outer, ring 12.

In addition, the first, inner, ring 11 has, on its outer peripheral wall 14, uniformly distributed elements in relief: these are radial ribs 15 shown in FIG. 1.

It should be noted that the outer peripheral wall 14 of the first ring faces the inner peripheral wall of the second ring 12.

To ensure its function as a noise damper, the device 1 exerts both a restraint of the motor 4 in the axial direction A2 of the motor, and a restraint of the motor 4 in a radial direction, perpendicular to the direction A2.

The second, outer, ring 12 has in particular the function of damping and/or preventing any axial movement of the motor 4. To do this, the second, outer, ring 12 bears both:
on an internal surface 35 of the cover 34, this internal surface 35 extending along a plane perpendicular to the axis A2 of the motor 4 when the cover 34 is fixed on the casing 3, and
on an external surface 45 of the motor 4, which is parallel to the annular internal surface 35 of the cover when the cover 34 is fixed on the housing 3 (and therefore also perpendicular to the axis A2 of the motor).

The external surface 45 of the motor forms an end part of the motor and the internal surface 35 of the cover 34 forms a bottom part of the cover 34.

The internal 35 and external 45 surfaces are therefore parallel to each other and the second ring 12 is sandwiched between these two surfaces in the closed position of the cover 34.

As for the first, inner, ring 11, it has the function of damping and/or preventing any radial movement of the motor 4 and, to do this, it bears both:
on an end wall 46 of the motor 4 which is cylindrical, of axis A2, and which forms a shoulder with the external surface 45 of the motor, and
on an annular bottom wall 36 of the cover 34, of axis A2 when the cover 34 is fixed on the housing 3.

The walls 46 and 36 are thus coaxial in the closed position of the cover 34 and the first ring is sandwiched between these two walls.

It should be noted that the annular wall 36 of the cover 34 therefore bears on the outer peripheral wall 14 of the first ring which carries the radial ribs 15: the radial ribs are thus crushed against the wall 36.

This characteristic makes it possible to avoid overstressing by using the space between the ribs.

The first, inner, ring 11 also bears against another annular surface 37 of the bottom of the cover 34, also of axis A2, this other annular surface 37 thus being coaxial with the annular wall 36 of the cover and forming a shoulder with the internal surface 35 of the bottom of the cover 34.

In this way, the first ring 11 of the device 1 according to the invention bears against a first radial shoulder (formed between the surface 45 and the wall 46 of the end part of the motor 4). Also, the second ring 12 bears against a second radial shoulder of the bottom of the cover in the closed position (the second shoulder being formed between the surface 35 and the annular surface 37).

It should be noted, in addition, that the first shoulder (45, 46) of the end part of the motor 4 and the second shoulder (35, 37) of the cover in the closed position face each other.

This is how this configuration ensures radial and axial damping of the motor in the housing 3 subjected to vibration. And this leads to a limitation of the noises produced by the elements that the motor gear unit 2 comprises.

To facilitate the positioning and holding of the damping device 1 on the end part of the motor 4, there is also provided a projecting bead 16 (see FIG. 3) on the free edge of the connecting ring 13 which is in line with the inner wall of the first ring 11.

The projecting bead 16 is designed to fit into a groove 42 arranged in the end part of the electric motor 4, at the junction between the external surface 45 and the cylindrical wall 46 of the motor 4.

Indeed, in this embodiment, the cover 34 and the damping device 1 are produced separately and are assembled one after the other in the motor gear unit 2.

This embodiment makes it possible to apply the invention to existing motor gear units.

Nevertheless, to facilitate assembly, provision could be made for the damping device 1 to be overmoulded in the cover 34: it would thus be secured to the cover, which would reduce the assembly time of the motor gear unit 2.

Provision could also be made to produce a cover and a damping device in a single piece by moulding.

By virtue of the presence of the damping device 1, between the end of the electric motor 4 and the bottom of the cover 34, it is observed that the loudness of the recorded noises, produced by the motor gear unit 2, can drop by 2 dB.

It is understood from the preceding description how the invention makes it possible to reduce the noises generated by the motor gear unit in operation, and in particular those generated by the electric motor in the housing 3 of the motor gear unit 2.

It should be understood that the invention is not limited to the embodiment specifically described and that it extends to the implementation of any equivalent means. In particular, the implementation of a damper 1 associated with a housing 3 without a motor opening and cover 34 does not depart from the scope of the present invention.

### REFERENCE SIGNS

1 damping device
2 motor gear unit
3 housing of the motor gear unit
4 electric motor
5 reduction mechanism
11 first ring
12 second ring
13 coaxial connecting ring
14 outer peripheral wall of the first ring
15 radial ribs
16 protruding positioning bead
30 upper part of the housing
31 first cylindrical shape
32 second cylindrical shape/lower part of the housing
33 cover of the upper part of the housing
34 cover of the lower part of the housing
35 internal surface of the cover perpendicular to the axis A2 of the motor
36 annular bottom wall of the cover
37 bottom annular surface
41 motor shaft
42 groove accommodating the bead
45 external surface of the motor
46 cylindrical end wall of the motor
50 output of the reduction mechanism
51 drive shaft
A1 output shaft of the reduction mechanism
A2 motor shaft

1. A motor gear unit for a disc brake electric actuator,
said motor gear unit comprising: a housing containing an electric motor having an axis defining an axial direction; and a reduction mechanism mechanically connected to said electric motor to provide at the output of said reduction mechanism a rotational drive of a shaft along an output axis parallel to said axial direction; the motor gear unit comprising:
a damping device capable of being positioned on an end part of the electric motor, comprising an element for axial damping of movements of the motor in said axial direction and an element for radial damping of the movements of the motor in a radial direction of the electric motor;
said damping device comprising two coaxial rings, among which:
a first ring which bears against a cylindrical wall presented by said end part of the electric motor, said first ring forming said radial damping element, and
a second ring which bears against an external surface of the motor perpendicular to said axial direction, said second ring forming said axial damping element;
the first ring and the second ring are radially connected to each other by a connecting ring, in that the first ring is positioned inside the second ring and bears against a first shoulder that the end of the motor presents.

2. The motor gear unit according to claim 1, characterized in that it comprises a cover having an annular surface and in that said cylindrical wall and the annular surface are axially offset relative to each other when the cover is fixed on the housing.

3. The motor gear unit according to claim 1, characterized in that the connecting ring comprises a bead for radial positioning, capable of fitting into a groove arranged in said end part of the electric motor.

4. The motor gear unit according to claim 1, characterized in that the first ring has at least one element in relief on its outer peripheral wall.

5. The motor gear unit according to claim 4, characterized in that said first ring has several elements in relief uniformly distributed over said outer peripheral wall.

6. The motor gear unit according to claim 1, characterized in that the damping device is produced in a single piece by moulding.

7. The motor gear unit according to claim 1, characterized in that the damping device is produced from ethylene-propylene-diene monomer and has a Shore D hardness comprised between 30 and 50.

8. A cover for a motor gear unit according to claim 1, said housing of said motor gear unit having an opening for access to the electric motor, said cover being capable of closing said opening for access to the electric motor, said cover being equipped with a damping device comprising an element for axial damping of the movements of the motor in said axial direction and an element for radial damping of the movements of the motor in a radial direction of the electric motor, the damping device comprising two coaxial rings, among which:
a first ring, capable of bearing against a cylindrical wall presented by said end part of the electric motor, said first ring forming said radial damping element, and
a second ring, capable of bearing against an external surface of the motor perpendicular to said axial direction, said second ring forming said axial damping element; the first ring and the second ring are radially connected to each other by a connecting ring, and in that the first ring is positioned inside the second ring; and
the damping device is produced in a single piece with the cover.

9. An assembly comprising a disc brake, in particular with a movable, in particular sliding, caliper, and an actuator associated with a motor gear unit according to claim 1.
